(19) United States
(12) Patent Application Publication
(10) Pub. No.: US 2002/0194528 A1
(43) Pub. Date: Dec. 19, 2002

(54) Method, disaster recovery record, back-up apparatus and RAID array controller for use in restoring a configuration of a RAID device

(76) Inventor: Nigel Hart, Frampton Cotterell (GB)

Correspondence Address: LOWE HAUPTMAN GILMAN & BERNER, LLP, Suite 310, 1700 Diagonal Road, Alexandria, VA, 22314, US

(21) Appl. No.: 10/152,340

(22) Filed: May 22, 2002

(30) Foreign Application Priority Data
May 22, 2001 (GB) 0112383.5

(51) Int. Cl. G06F 11/08

(52) U.S. Cl. 714/6

(57) ABSTRACT

A computer system has (1) an array of data storage devices, (2) an operating system stored on a RAID device and (3) a RAID controller. In response to detection of a computer system failure, the RAID device configuration is automatically restored. A system back-up memory stores a recovery record of physical drive to logical drive mapping for the RAID device. The RAID controller enables the recovery record to be processed in response to detection of a system failure. In response to computer system failure detection, the recovery record information restores the RAID array configuration. Following system failure, a computer system manager instigates the procedure by pressing a button.

### FIELD OF THE INVENTION

The present invention relates to the field of computing, and particularly although not exclusively to a method and apparatus for reconfiguration of a raid array after the occurrence of a failure, such as a system crash, and wherein the system is stored as an image on a RAID array.

### BACKGROUND TO THE INVENTION

It is known to image computer systems on a redundant array of independent inexpensive disks or drives (RAID) controlled by a RAID controller. RAID arrays are known to be beneficial over single hard disks in that a single error on a hard disk can corrupt the entire data content thereof whereas distributing relevant data and operating commands over a plurality of disks or drives, with redundancy, ensures that any errors may be corrected as required. RAID data storage systems comprise redundant information which can be used to detect and correct errors. In relation to single hard disk systems, Hewlett Packard Company have devised a system known as “One button disaster recovery” (OBDR) which, as its name suggests, is designed to enable a computer system to be recovered at the press of a single button—the system is fully described in International patent publication number WO 00/08561. Such an automated disaster recovery process is required so as to take away substantially all technical knowledge required by a given user attempting to reconfigure a given failed computer system which is stored on the hard drive.

The system described in WO 00/08561 concerns back-up and recovery of a computer system having a single hard disk such as a PC operating under, for example, a Windows™ NT operating system environment. The system described may equally be used on servers, notebooks or laptop computers and the like. FIG. 1 schematically illustrates the prior art system described in WO 00/08561 and comprises a tape drive 101 configured to operate as a bootable device for a PC 100. The tape drive 101 has two modes of operation: a first in which it operates as a normal tape drive 101; and a second in which it emulates a bootable device such as a CD ROM drive. The system described provides application software for backing up and restoring computer system data, the application software being configured to cause PC 100 running the software to generate a bootable image (containing an operating system, including the PC 100, hard ware configuration, and data recovery application software) suitable for rebuilding the PC 100 in the event of a disaster. Typical everyday disasters include, for example, a hard disk corruption, system destruction or virus induced problems. The bootable image is stored on tape in front of an actual file system back-up data set. In the second mode of operation, the tape drive 101 can be used to boot the PC 100 and restore the operating system and application software. When loaded, the application software is configured to switch the tape drive 101 into the first mode of operation and restore the file system back-up data set to the PC 100. The system of FIG. 1 confirms system back-up and recovery for computer systems comprising a hard disk drive 102 connected to a host bus adapter (HBA) 103. HBA 103 is connected to input/output device 104 which in turn communicates with RAM 105, ROM 106 and microprocessor 106 respectively via bus 107. Hard disk 102, via HBA 103, communicates with tape drive 101 via a suitably configured communications link 108. The tape drive 101 may comprise a modified standard digital data storage (DDS) tape drive, digital linear tape (DLT) tape drive or other tape media device. The 10 sub-system 104, as shown, connects PC 100 to a number of storage devices, namely a floppy disk drive 109 and, via the SCSI (Small Computer Systems Interface) HBA 103 to the hard disk drive 102 and the tape drive 101. The tape drive 101 may either represent an internal or external device in relation to PC 100. Tape drive 101 communicates with PC 100 via communications bus 107 which connects to host interface 110 which is configured to control transfer of data between the two devices. Control signals received from PC 100 are passed to controller 111 which is configured to control the operation of all components of tape drive 101. For a data back-up operation, in response to receipt by the host interface 110 of data write signals from the PC, controller 111 causes tape drive 101 to write data to tape. The steps involved include: the host interface 110 receiving data from PC 100 and passing it to formatter module 112 which formats the data through compression, error correction etc. The formatted data is stored in buffer 113. A read/write device 114 reads the stored formatted data from buffer 113 and converts this data into electrical signals suitable for driving magnetic read/write heads 115 which write the data to tape media 116 in the known fashion.

Data restore processing works as follows. Read signals received from PC 100 via host interface 110 cause controller 111 to control tape drive 101 so as to return data to PC 100. The heads 115 are configured to read data from the tape media 116 whereafter the read/write block 114 is configured to convert the signals into digital data representation and then to store the data in buffer 113.

Formatter 112 thereafter is configured to read the data from buffer 113, remove errors and decompress etc. and then pass the data to host interface 110. Upon receipt of data host interface 110 is configured to pass the required data to HBA 103.

Although RAID arrays are a substantial improvement in terms of error recovery as compared with single disk technology there is a problem with use of RAID controllers when trying to utilize an OBDR approach to recovery. It is well-known that there are various array models or RAID levels, such as RAID 1—mirroring, RAID 3—parallel transfer disks and RAID 5 independent access array with rotating parity. Each RAID level corresponds to a particular type of implementation of storage of data on a RAID array and thus a RAID controller is required to comprise data describing a mapping between the physical hard drives and the logical hard drives created by virtue of the RAID level selected for use in a given implementation. In other words, a computer operating system stored on a RAID will be distributed across a plurality of physical drives, enhancing reliability, mapping data being required to map the physical hard drive addresses to logical hard drive addresses.

In existing RAID array systems the physical-logical mapping data is known to be stored in non-volatile (NV) RAM on the NV-controller card and also on the physical RAID drives. This double storing is required so as enable the RAID controller to effectively detect any difference arising between the two stored versions. Upon any stored difference being detected the RAID controller is configured to indicate such a discrepancy to the system operator. This usually results in a large number of questions being directed to the system operator. Such questions may typically not be within the capability of a system operator to answer, or at least may take a considerable time to sort out. Thus, there is a problem that RAID computer systems, either stand alone or networked, upon detecting an error in a RAID controller stored mapping data, may be rendered “down” for a considerable time. Thus, there is a need to simplify recovery of RAID computer systems in general so as to reduce the length of time that the computer system remains in a pre-recovered state. With the increase in users buying systems configured with RAID controllers recovery of such systems is problematic with many system managers unable to undertake the required corrective actions. Users may typically not be equipped with the required technical expertise to re-initialise their RAID controllers configuration mapping to that required to make the restoration. As far as the inventors are aware there is no currently available automated one-button type solution to re-configuring the RAID mapping(s) required to make the restoration.

In summary, when the hard disk of a computer system, such as that schematically illustrated in FIG. 1, is replaced with a RAID array, as is common in business and in industry, then the methods and apparatus disclosed in WO 00/08561 are found to function incorrectly resulting in a multitude of problems such as lost data. Therefore, there is a need to generate additional apparatus and methods to those disclosed in WO 00/08561 so as to enable one button type system back-up and recovery methods to be utilized in a computer system comprising a RAID array.

### SUMMARY OF THE INVENTION

One object of the present invention is to provide a method and apparatus for enabling “one button disaster recovery” to be effected by a wider range of system managers having a range of experiences in terms of system recovery.

Another object of the present invention is to provide a method and apparatus for enabling RAID re-configuration of the mapping between physical and logical drives following detection of an error in the mapping data.

Another object of the present invention is to enable a RAID controller to both detect mismatched mapping data and restore a computer-system in as short a time as possible.

A further object of the present invention is to provide an automated disaster recovery process which is not dependent upon substantial intervention by a skilled system operator.

Yet a further object of the present invention is, for RAID computer systems, to enable a user to be able to switch a system back-up device into a Disaster Recovery (DR) mode with one button, and therefore re-boot the system to recover it to the last back-up state without further intervention.

According to a first aspect of the present invention there is provided in a computer system comprising an operating system stored on a RAID device comprising an array of data storage devices and a RAID controller, an automatic method of substantially restoring a configuration of said RAID in the event of a system failure, said method comprising the steps of:

on a system back-up memory device storing a record of physical drive to logical drive mapping information for a RAID device;

configuring said RAID controller to enable said recovery record to be processed in response to a detected system failure; and

in response to said detected system failure, utilizing said recovery record information to restore said configuration of said RAID array.

Preferably, said automatic restore comprises an OBDR procedure initiated by an operator of said system.

According to a second aspect of the present invention there is provided an electronically stored disaster recovery record configurable for use in recovering a computer system from a system failure, said record comprising information relating to the configuration of a plurality of logical drives of a RAID array, said configuration information comprising at least the following for each said logical drive:

RAID controller identity;

logical drive size (Gigabytes); and

RAID level.

Preferably, said configuration information additionally comprises the span of each said logical drive; and the number of RAID stripes for each said logical drive.

According to a third aspect of the present invention there is provided a computer system back-up apparatus configured for storing back-up information of a RAID computer system, said apparatus comprising means for recording:

system back-up data;

a bootable CD image of said system; and

a disaster recovery record wherein said disaster recovery record comprises mapping information between physical and logical hard drives of said RAID computer system prior to a disaster.

According to a fourth aspect of the present invention there is provided a RAID array controller configured for use in a RAID array computer system, said RAID array controller being further configured to create a disaster recovery record of physical-logical mapping information of said RAID array and thereafter to enable transmission of said recorded information to be made to a data back-up storage device.

Other features of the invention are as specified in the claims herein.

### BRIEF DESCRIPTION OF THE DRAWINGS

For a better understanding of the invention and to show how the same may be carried into effect, there will now be described by way of example only, specific embodiments, methods and processes according to the present invention with reference to the accompanying drawings in which:

FIG. 1 schematically illustrates a prior art single hard drive computer system back-up and recovery apparatus configured to enable simple one button disaster recovery (OBDR) from a system failure;

FIG. 2 schematically illustrates, in accordance with the present invention, a computer system comprising an operating system stored on a RAID array, the array being controlled by a RAID controller stored, for example, on RAM and communicating with a microprocessor and a system back-up device such as a back-up tape;

FIG. 3 schematically illustrates an example of physical and logical layers associated with a RAID array of the type identified in FIG. 2;

FIG. 4 schematically illustrates a basic flow diagram of system operation for an automated known recovery system, of the type disclosed in WO 00/08561, when used in conjunction with a computer system comprising a RAID array;

FIG. 5 schematically illustrates an electronically stored disaster recovery record (DRR) for use in recovering a RAID computer system as configured in accordance with the present invention;

FIG. 6 schematically illustrates a recovery process of the type configured in accordance with the present invention through a RAID controller utilising an electronically stored back-up DRR of the type schematically illustrated in FIG. 5;

FIG. 7 schematically illustrates a sub-set of the table illustrated in FIG. 5 intended to aid illustration of the principles underlying use of the record in practice;

FIG. 8 schematically illustrates the mappings required for the specifications as set in the exemplary sub-set table of FIG. 7.

FIG. 9 schematically illustrates a further example of a reduced table of a type similar to that of FIG. 7;

FIG. 10 details mappings required in relation to FIG. 9;

FIG. 11 schematically illustrates the steps involved in generation of a disaster recovery record (DRR) as provided in accordance with the present invention; and

FIG. 12 schematically illustrates, in accordance with the present invention, the positional arrangements of a back-up data set body, a bootable CD image and a disaster recovery record, the disaster recovery record in fact being stored in front of the other stored information.

### DETAILED DESCRIPTION OF THE BEST MODE FOR CARRYING OUT THE INVENTION

There will now be described by way of example the best mode contemplated by the inventors for carrying out the invention. In the following description numerous specific details are set forth in order to provide a thorough understanding of the present invention. It will be apparent however, to one skilled in the art, that the present invention may be practiced without limitation to these specific details. In other instances, well known methods and structures have not been described in detail so as not to unnecessarily obscure the present invention.

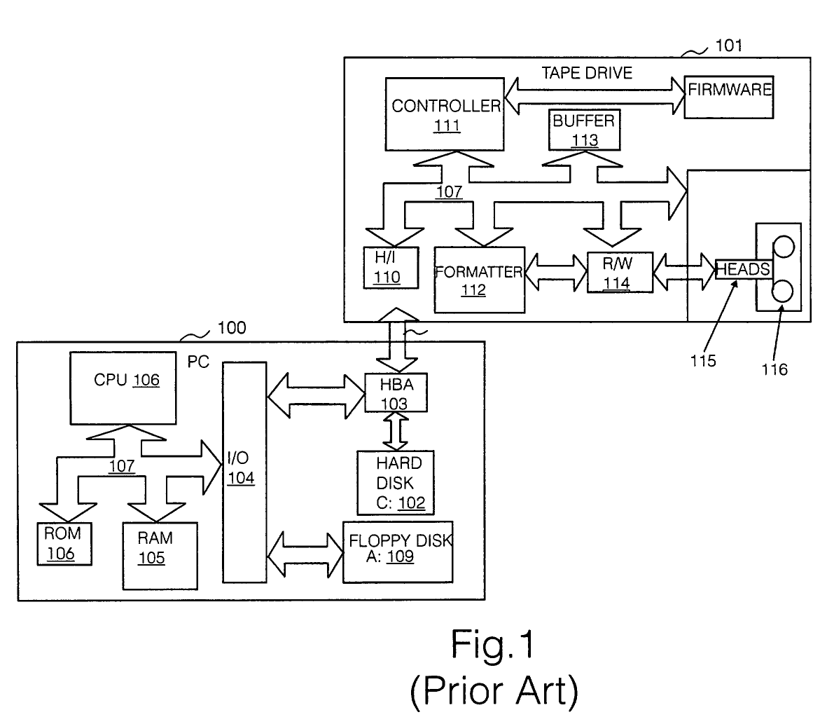

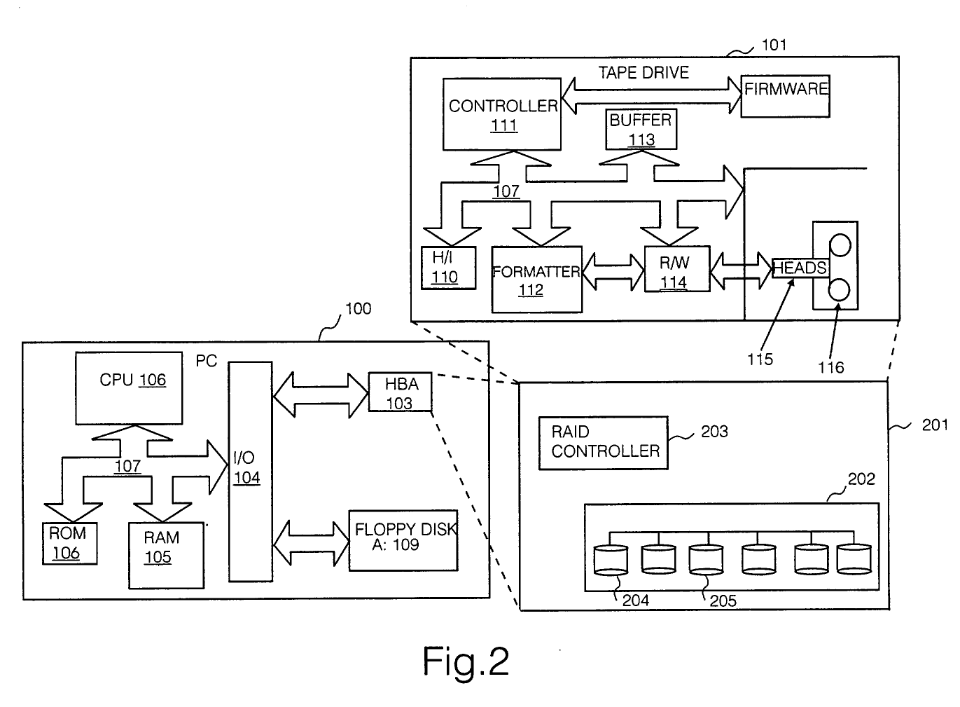

FIG. 2 schematically illustrates a computer system of the type illustrated in FIG. 1, but wherein the hard disk has been replaced by a RAID unit 201 comprising a RAID array 202 controlled by a RAID controller 203. RAID array 202 comprises a plurality of suitable known RAID disks or drives 204, 205. RAID controller 203 communicates with HBA 103 via communications bus 206. RAID unit 201 may typically be configured in a manner external to PC 100 as shown, although various other configurations can be utilized as required. RAID unit 201 operates in a substantially different manner to a conventional hard disk in that an operating system may be stored on a plurality of physical drives 204, 205 etc. which require ordering into logical drives for correct operation of the operating system. Thus RAID controller 203, which may suitably be stored on non-volatile RAM, is configured to maintain a record of the system configuration including mapping information relating physical drive addresses to logical drive addresses for a given operating system and any other software stored on the RAID. It is known to store such mapping information in RAID controller 203 and it is also known to store the same mapping information on the drives comprising the RAID. The system configuration held by RAID controller 203 and RAID unit 202 may be compared and checked by the RAID controller. If a disaster has occurred, such as lost data or some other problem, then the RAID controller is configured to detect the difference between the two versions of stored mapping information and raise a warning to the user of PC 100 to the effect that the problem requires fixing. Current computer systems utilizing RAID technology are unable to automate disaster recovery in the manner described in WO 00/08561. This problem arises because the mechanisms of WO 00/08561 are not configured to record physical-logical mapping data of the type utilized when a RAID is incorporated in a computer system.

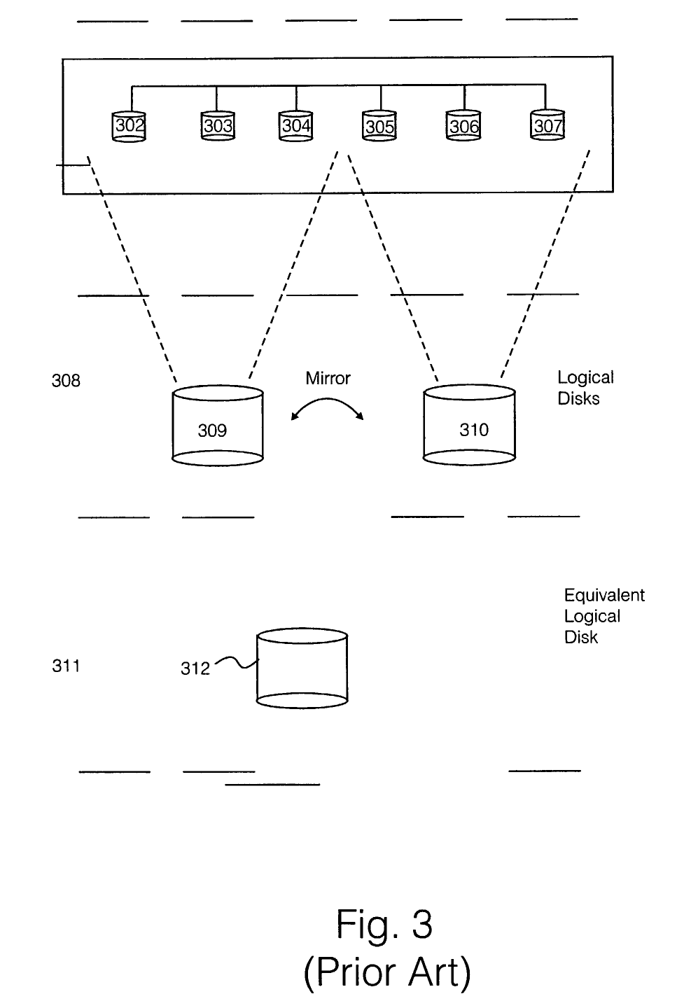

FIG. 3 schematically illustrates the relationship between physical drives and logical drives in a typical prior art RAID based computer system. Various array models or RAID levels are used in practice, for example RAID 1 or mirroring wherein all data is duplicated across the N disks/drives of the array so that the virtual disk has a capacity which is equal to that of a single physical disk. RAID 5 or independent access array with rotating parity is also commonly used wherein data is distributed in a more complex way than in RAID 1. FIG. 3 schematically illustrates physical RAID 301 comprising physical drives 302 to 307 respectively. Taking RAID level 1 logical layer 308 can be represented by two logical drives 309 and 310 respectively, each logical drive or disk being equal to three physical drives. Because each logical drive 309, 310 is a mirror image of the other then in effect the final logical layer is represented by a single drive 312.

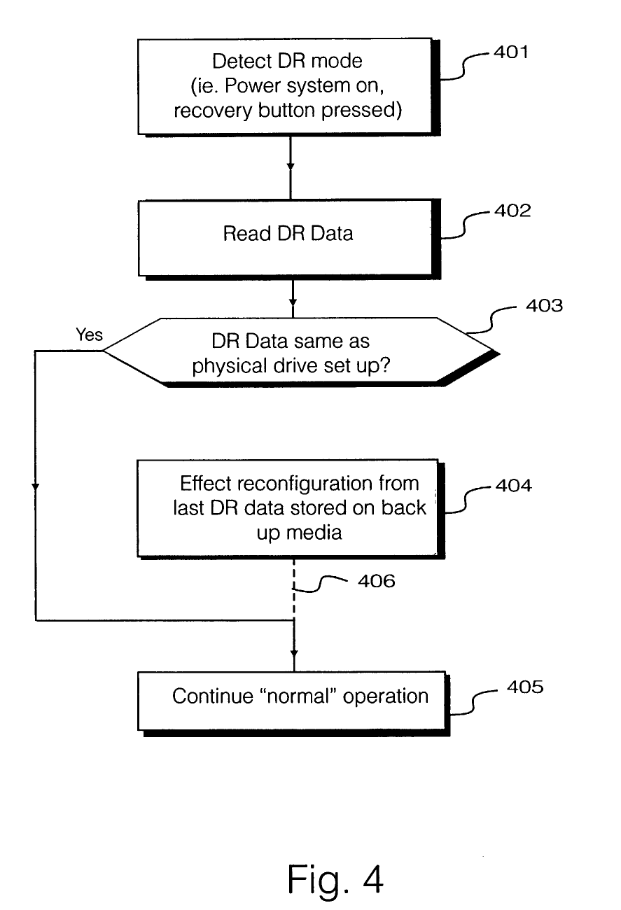

A basic flow diagram of system operation for a recovery system of the type disclosed in WO 00/08561 when used in conjunction with a computer system comprising a RAID for storing an operating system and other software is schematically illustrated in FIG. 4. At step 401, using the OBDR principle, the DR mode is detected by the RAID BIOS whereafter at step 402 DR data is read from the non-volatile RAMs. By DR data it is meant both a back-up data set and bootable data. If the DR back-up data set read at step 402 corresponds to the actual physical drive setup then the RAID controller is configured to simply allow the computer system to continue normal operation. However, if the question asked at step 403 is answered in the negative then the RAID BIOS is configured to effect reconfiguration of information stored on the RAID array by utilizing the configuration information stored on the bootable data set as recorded on the back-up media in accordance with the principles detailed in WO 00/08561. However, a problem exists which is that although the physical configuration may have been re-established correctly and although a suitably sized logical connection may have been established and although the RAID may therefore operate correctly there is no guarantee that the logical set up of the RAID is that which existed at the time of last back-up of the system. Thus, as shown by broken control line 406 control could effectively be passed to step 405 with resulting incorrect operation of the computer system. In other words, errors, discrepancies and the like will exist to varying degrees throughout the system. As an example, consider eight Gigabytes of data in an eight Gigabyte partition. If an available logical drive comprises less than eight Gigabytes then it obviously cannot restore the data. However, the fact that restoration cannot be undertaken correctly is only brought to the system operators attention at the end of the restore period and therefore at a time when all of the space of the logical drive created has been used. Certain data is not restored and the system will not come up correctly. The end result is that the rebooting procedure will need to be invoked again with manual intervention so that the problem or problems can be overcome effectively. This results in considerable time in which the system is down and in which substantial human intervention is required.

The problem discussed above in both the background and in relation to FIG. 4 is solved by the present invention by utilizing a disaster recovery record (DRR) which stores physical-logical drive mapping information and which may be utilized in rebooting a system prior to the operating system itself being recovered. Such a disaster record of physical-logical drive mapping information enables the stored rebooting software to ensure that the partition size is sufficiently large to ensure correct restoration can be achieved and therefore that the whole rebooting process will go through properly without further iterations being required.

This mechanism has potential for use as a software deployment tool, for example in situations where an operating system on a given computer system requires upgrading to the next generation.

The requirement regarding partition size is that the new allocated partition should be greater than or at least equal to the size of the partition previously allocated for a given data content.

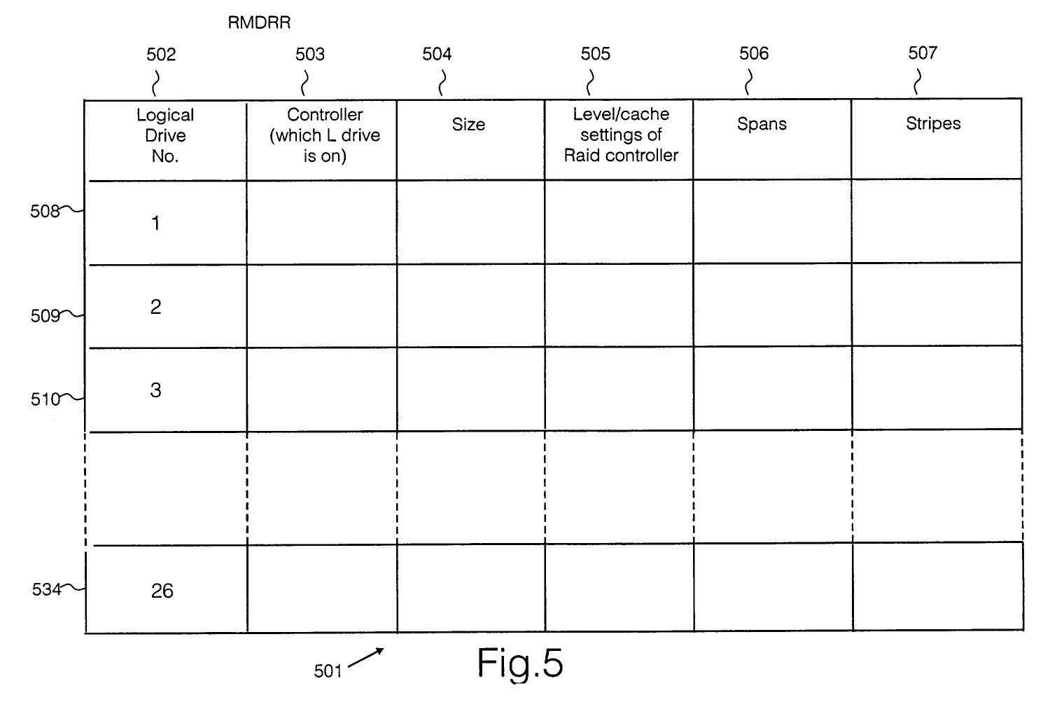

To correct the above identified problem the disaster recovery processing logic for a RAID based computer system requires, in accordance with the present invention, additional information as to the physical-logical drive configuration. FIG. 5 schematically illustrates the RAID mapping disaster recovery record (DRR) as configured in accordance with the present invention. The DRR may suitably comprise a table 501 having the ability to store up to 26 logical volumes. 26 logical volumes are particularly suitable for-the reason that “drive lettering” (for labeling purposes of the drives) typically uses the letters (A-Z) of the alphabet. Most modern known operating systems use such drive lettering. This drive lettering is in fact the labeling used by the software which runs the single drive OBDR process to undertake the back-up of the computer system.

Referring to FIG. 5 herein, table 501 is an example of one of a variety of possibilities that could be implemented as the skilled person will realize. In the example shown column 502 comprises information relating to the logical drive number (1-26); column 503, the controller which the logical drive is actually on; column 504, the size of the logical drive; column 505, the level/cache settings of the given RAID controller; column 506, the RAID spans and column 507, the RAID stripes. In effect the level/cache settings, for example, of the RAID controller will be dependent upon the given recovery software actually utilized and on the specific RAID configuration actually used. The table stores the mapping information which relates the physical and logical views of the RAID controller as for example schematically illustrated in the example of FIG. 3. Table 501 is required to enable re-establishment of the 26 represented logical drives (508-534), each logical drive potentially being made out of any combination of physical hard drives. The example given in FIG. 3 relating to RAID level 1 (mirroring) clearly illustrates that one logical drive or disk may comprise two logical mirrors each relating to three physical drives. Taking into consideration the fact that there are RAID levels R0-R6 then the situation can be considerably more complex and thus the table schematically illustrated in FIG. 5 is required to define these varied relationships between the physical drives and logical drives.

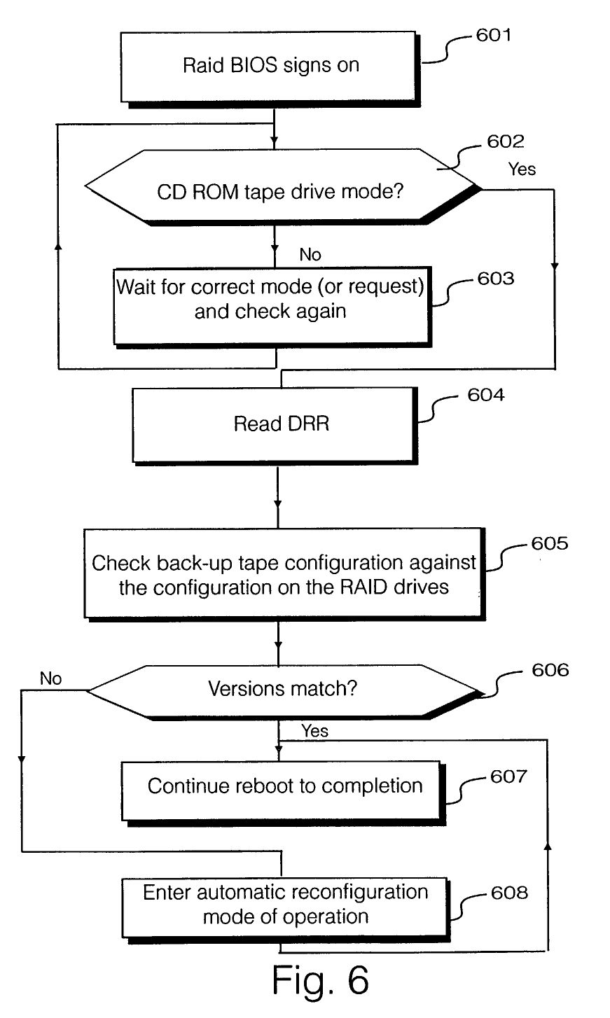

FIG. 6 schematically illustrates a recovery process of the type configured in accordance with the present invention through the RAID controller utilizing a table of the type illustrated and described in FIG. 5. Upon the RAID computer system being rebooted at step 601 the RAID BIOS signs on and checks for a CD ROM tape drive. In the OBDR mechanism of WO 00/08561 this in effect requires the RAID BIOS to look for an identifier string such as for example represented by “$DR”. If the tape drive is found to be in the CD ROM mode as checked at step 602 then the RAID BIOS is configured to read the DR record as configured in accordance with the table of the type schematically illustrated in FIG. 5. However, if the tape drive is not in the correct mode of operation then control is passed to step 603 wherein the RAID BIOS is configured, for example, to wait until the correct mode is entered into at step 602. Following entering the correct mode and reading of the DRR the RAID BIOS is, at step 605, configured to check the back-up tape configuration versus the configuration stored on the RAID drives so as to determine if the two configurations match. At step 606, if a match is found then the rebooting simply continues (step 607) since the DRR mapping is then deemed to be correct as compared with the back-up tape version. However, if the version stored on the drive is found to be different from that stored on the back-up tape then recovery software is configured to enter an automatic reconfiguration mode of operation at step 608. This feature is suitably implemented in the RAID BIOS and effectively causes the RAID to be reconfigured in accordance with the mapping information obtained from the backup stored DRR record.

Automatic re-configuration (step 608) comprises the RAID BIOS being configured to use the physical drive—logical drive mapping record (DRR) so as to re-create a sufficient logical configuration in the physical hard drives of the RAID array. Thus, the automatic re-configuration may optimize the re-configured sufficient logical arrangement or may be configured to take a simple “best-fit” type of approach. Once automatic re-configuration is completed the required logical and physical configuration of the RAID drives will be restored and therefore control can effectively be passed back to the normal booting process at step 607 whereafter the rebooting process, once completed, is terminated.

Following successful re-establishment of a sufficient correct configuration of the logical drives for the system under consideration, as detailed above, control is effectively thereafter passed back to complete the OBDR procedures as detailed in WO 00/08561. Usage of the DRR thus guarantees that when the OBDR procedures are invoked the remainder of the re-booting is guaranteed to work correctly and therefore wasting of time and undue human intervention (as was the case in the situation described in FIG. 4) is negated.

The present invention solves the problems identified in relation to the discussion of FIG. 4 by storing the RAID configuration on a suitably configured tape drive, the stored RAID information thereafter being used to correct the mapping of physical-logical drive usage, prior to the operating system being recovered. Thus, the present invention concerns changes made to a standard tape drive of the type disclosed in WO 00/08561 so as to allow such a tape drive to store a given record of physical-logical mapping data and also concerns simple changes to a standard RAID controller firmware so as to allow the controller to use the mapping record to regenerate the required RAID configuration.

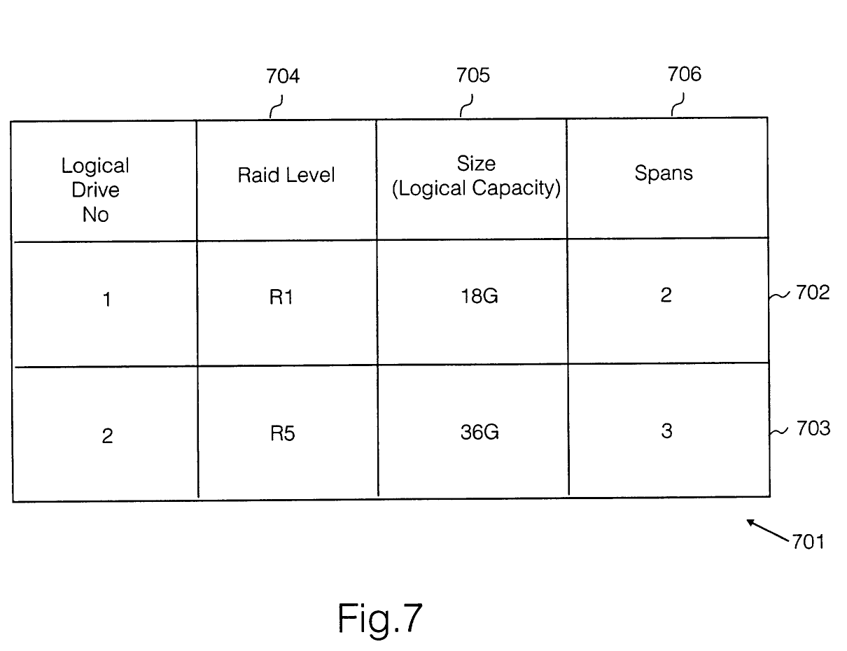

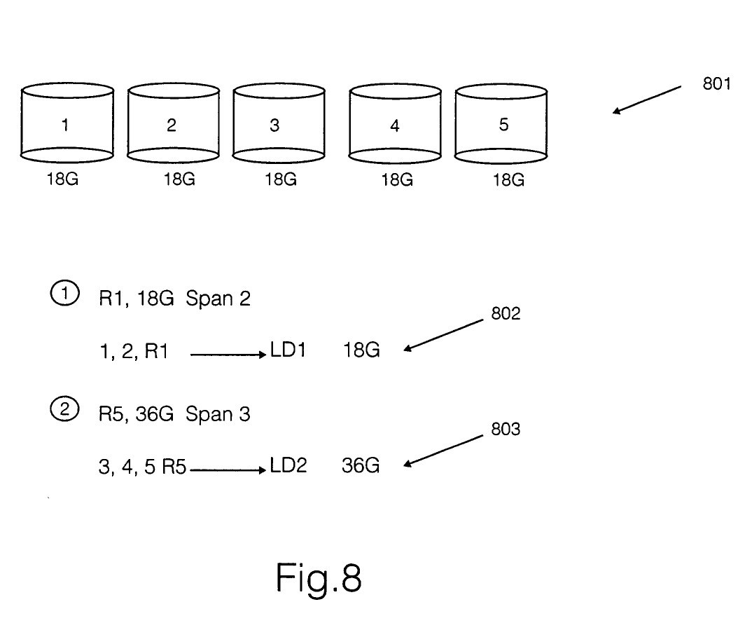

FIG. 7 schematically illustrates a sub-set of the table illustrated in FIG. 5 so as to illustrate more clearly the principles underlying how the table actually works in practice. The table 701 comprises two logical drives, the data for which is held in row 702 and row 703 respectively. The information comprised in the table for each logical drive comprises RAID level in column 704, logical drive size in column 705 and the span feature in column 706. Thus column 705 concerning size relates to logical capacity and column 706 represents how many drives are in the particular RAID array under consideration. In the example shown logical drive number 1 is configured at RAID level 1 (R1), has a logical capacity of 18 Gigabytes and has a span of 2. Logical drive number 2 comprises RAID level R5, has a logical capacity of 36 Gigabytes and has a span of 3. The RAID controller 203 is configured to read table 701 and assess the suitability of the physical hard drives to accommodate the requirements of the table. For example, referring to FIG. 8, if there are 5 hard drives (801) numbered 1-5 respectively, each of 18 Gigabytes physical capacity, then the RAID controller 203 first assesses the physical drives in relation to logical drive number 1 and finds that the RAID level is R1, the required logical capacity is 18 Gigabytes and that the span required is 2. The RAID controller then assesses the physical drives in order. In the present example, the RAID controller finds that physical drives 1 and 2 will go together as a RAID 1 configuration, that they will provide 18 Gigabytes capacity and that the required span is 2 (span =2 implies 2 hard drives required). Therefore, physical drives 1 and 2 become the logical mapping for logical drive number 1 which requires a logical capacity of 18 Gigabytes and the RAID level R1 to be provided. This mapping function may be written as follows:

1, 2 R1→LD1 18G

and is generally indicated at 802.

Following establishment of the required mapping for logical drive number 1, the RAID controller is configured to establish the required mapping to physical drives for the next logical drive, in this case logical drive number 2. In this case, RAID controller 203 finds that it requires a RAID level R5 of capacity 36 Gigabytes and a span of 3. In the present example the remaining three physical drives, physical drives 3, 4 and 5, are available and thus the RAID controller establishes that physical drives 3, 4 and 5 can be put together in a RAID 5 configuration having a capacity of 36 Gigabytes. This can conveniently be represented as follows:

3, 4, 5 R5→LD236G

and again is generally indicated at 803.

The process is more complicated in practice, but the above example illustrates the underlying principles as those skilled in the art will understand. The process is iterative and relies on taking the next available storage to satisfy the requirements of the table.

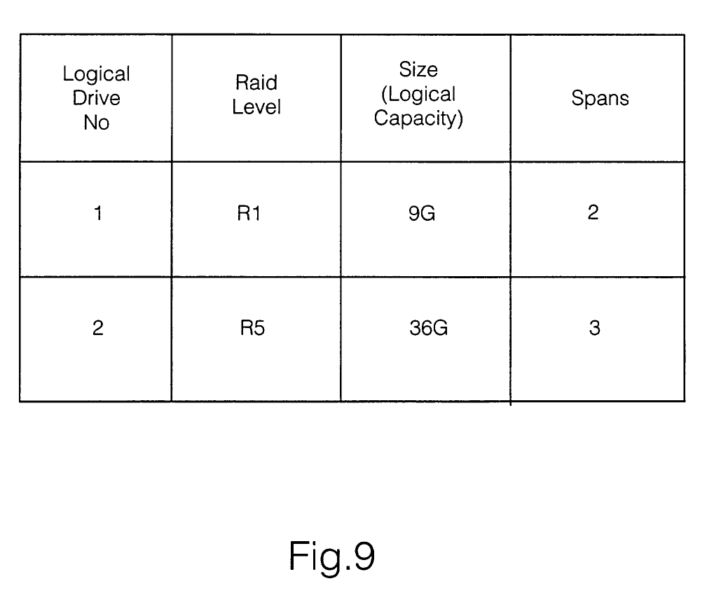

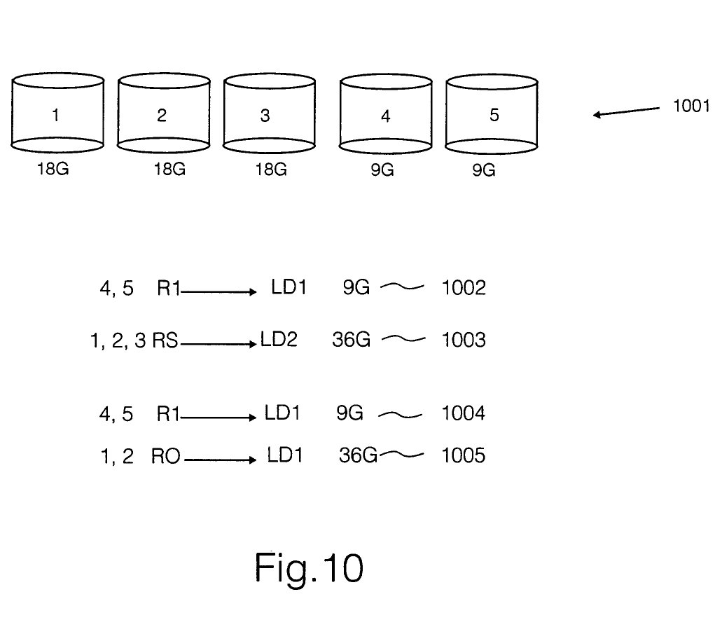

A second example is given in FIGS. 9 and 10. In this example the five physical -drives numbers 1-5 have the following size capacities: numbers 1-3, 18 Gigabytes; and numbers 4-5, 9 Gigabytes. The DRR table requirements are as indicated in FIG. 9: logical drive number 1 having a RAID level of 1, size of 9 Gigabytes and a span of 2; logical drive number 2 having a RAID level of 5, size of 36 Gigabytes and a span of 3. The RAID controller assesses the requirements of logical drive number 1 and thereafter assesses physical drives 1-5 in order to establish which physical drives are best for implementation of logical drive number 1. Upon RAID controller 203 determining that physical drive number 1 has a size of 18 Gigabytes it is configured to determine that this is not the most efficient use of physical drive number 1 and therefore assesses drive number 2 and drive number 3 respectively finding that the size capacity is also 18 Gigabytes. However, upon reaching physical drive number 4 the RAID controller determines correctly that this has a size of 9 Gigabytes and also that drive number 5 has a size of 9 Gigabytes. Thus, the required mapping for logical drive number 1 is that it can be implemented using physical drives 4 and 5 which can be configured in a RAID 1 level. This is schematically illustrated in functional notation at 1002. Then the RAID controller assesses the requirements of logical drive number 2, that is the next logical drive listed in the table, and finds that a capacity of 32 Gigabytes is required for a RAID 5 level having a span of 3. Thus, the RAID controller assesses the remaining drives and finds that physical drives 1, 2 and 3 will provide the required logical drive as indicated at 1003 in FIG. 10.

As seen above, a fairly simplistic approach can be taken to successfully regenerate the logical configuration. In the last example, where 36 Gigabytes were required, drives 1, 2 and 3 add up to 54 Gigabytes but because of the nature of RAID storage in relation to the level the redundancy means that 54 Gigabytes for a RAID is equivalent to 36 available Gigabytes, in other words, for a RAID 5 one drive is lost as is well known to those skilled in the art. To effect such calculations the RAID controller is pre-programmed with the required information as is known. However, the relevant rules of RAID configuration and the like are not necessarily understood by many computer system operators and therefore sorting out a system failure using prior art methods can be extremely time consuming and complex.

The above described approach to solving the problem is considered to be the best mode and, as those skilled in the art will realize, does not necessarily lead back to the precise configuration that the computer system had before the disaster requiring attention occurred. The inventors have found that it is not necessary to configure RAID controller 203 with logic to produce exact reconfiguration in connection with every possible circumstance and also the present approach has been found to be less complex in the required logical processing. Thus, the required BIOS code is relatively simple and can readily be implemented by those skilled in the art. The system is best configured to attend to logical drive 1 followed by logical drive 2 and so on. This is because, typically, logical drive 1 will normally be the operating system's drive and therefore, attending to logical drive 1 first means that the operating system can normally be brought back up into an operational state as opposed to being hindered by waiting for other logical drives and applications held thereon to be brought into operation first. As an example, a server may be running Exchange™ and SQL.

The operating system may be held on a first drive, ExchangeTM on a second drive and the SQL database on a third logical drive. Under these circumstances it is clearly beneficial to bring up the operating system first followed by the Exchange™ software followed by the SQL database. In the event that the database cannot be brought up to operation then at least the system operator has the benefit of the operating system being up and running. With prior art methods of attending to recovery a typically system operator may be inundated with too many combinations to try in relation to which logical drives would be suitable for which application. Thus, utilization of a DRR table of the type detailed in FIG. 5 clearly has many advantages and saves a vast amount of time from a system operators point of view. The table, in effect, orders the possibilities for the RAID controller so that the RAID controller 203 can obtain some clues as to where to start in allocation of logical drives for given applications. Therefore, in effect, the RAID controller is alleviated from the possibility of having to go through all possible permutations of logical drives and thus the methods described above may be considered to be a simplistic top-down approach to an otherwise relatively complex problem.

The RAID controller, as seen above, is configured to use a set of rules based on what the RAID levels are and what the capacity requirements are. These rules for RAID levels are, as is well-known to those skilled in the art, industry standards which are stored in the RAID controller database.

RAID BIOS processing logic can be further enhanced to provide for alternatives. For example, referring again to FIG. 10, if physical drive 3 did not exist then the result for logical drive number 1 would be the same and correspond to that identified at 1002. However, in relation to logical drive number 2, the only available drives left would be physical drives 1 and 2. For redundancy, a result 1003 would be required, but in the present case this would not be possible. In this circumstance, as could occur at the end of processing, the RAID controller is configured to consider alternatives and therefore would be configured to conclude that drives 1 and 2 could be utilized to provide the required capacity of 36 Gigabytes, but without the required redundancy, that is by way of allocating a RAID 0 level utilizing physical drives 1 and 2 to provide the required 36 Gigabytes capacity. The resultant allocations are indicated in FIG. 10 at 1004 and 1005 respectively.

The one button disaster recovery approach detailed in WO 00/08561 requires the required capacity to be made available and therefore implementation of the feature of alternative raiding strategies so as to come up with the required capacities is considered necessary within the RAID controller BIOS logic. In summary, the RAID logical is configured to enable the system to return to an up and running state substantially exactly, in functional terms, to that which it was in prior to the disaster. However, if a suitable physical-logical drive mapping can be found which at least provides the right logical capacity, albeit out of a different RAID level then this should be provided as an option as well.

System recovery and back-up is therefore greatly enhanced by utilization of a record of the type schematically illustrated in FIG. 5 and detailed in terms of use in FIGS. 6-10. The way that the RAID logic and the table itself are actually implemented may vary depending upon a given operators requirements and upon a manufacturer's chosen specifications. As those skilled in the art will realize, there is a fair degree of flexibility with regards certain aspects of the design of both the table and the required RAID BIOS logic.

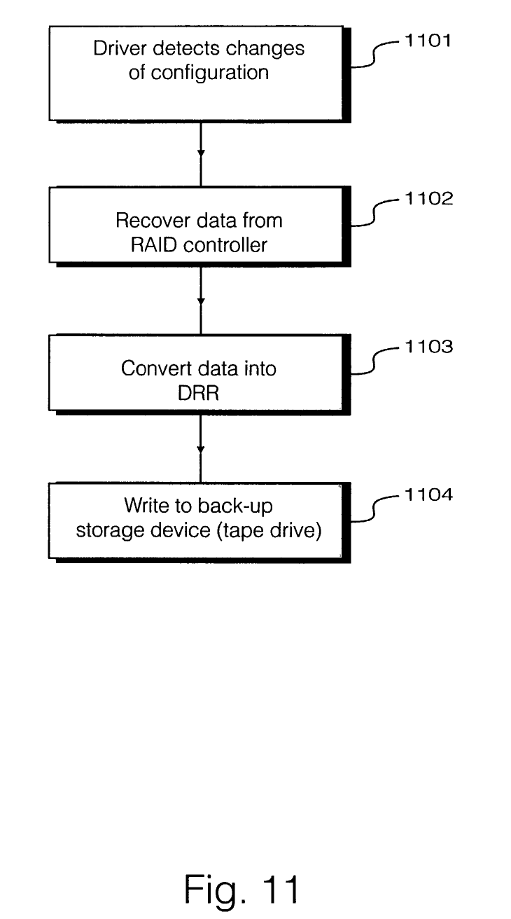

FIG. 11 schematically illustrates the steps involved in generation of the DRR which has to be generated within the operating system of the computer system itself. The reason that the DRR is required at the operating system level is that it needs to be accessible by all RAID controllers operating within the system and thereby offers protection to the whole system rather than just a portion thereof. Although it is considered best to implement the DRR at a fairly high level it is possible to implement it in various other ways, for example on a RAID controller level basis. However, if such a table was implemented at a RAID controller level then multiple records would be required and required processing logic becomes more complex and therefore is less than straight forward. Thus, in the best mode the DRR is considered to be required to be implemented at the operating system level.

The means of generating the DRR is provided by a driver configured in the operating system to look for changes of configuration. The RAID controllers are configured to allow the storage requirements to be dynamically changed. In other words, and as is known to those skilled in the art, the RAID controllers enable array levels to be changed, for capacity to be added and for new logical drives to be brought into use as required. When changes of configuration occur and are thereby detected, the relevant driver is given an appropriate signal to this effect and is thereafter configured to recover the data from the RAID controllers and convert this into the DRR which is in turn written by the driver to the back-up storage device such as a suitably configured tape drive. FIG. 11 schematically illustrates generation of the DRR. At step 1001 the driver -detects changes in configuration and thereafter recovers the data confirming the changes from the RAID controller at step 1102. Following step 1102 the driver is configured to convert the data changes into the required DRR record as indicated at step 1103. Following step 1103 the relevant information concerning the data changes is written to the back-up data storage device which may comprise a suitably configured tape drive as indicated at step 1104.

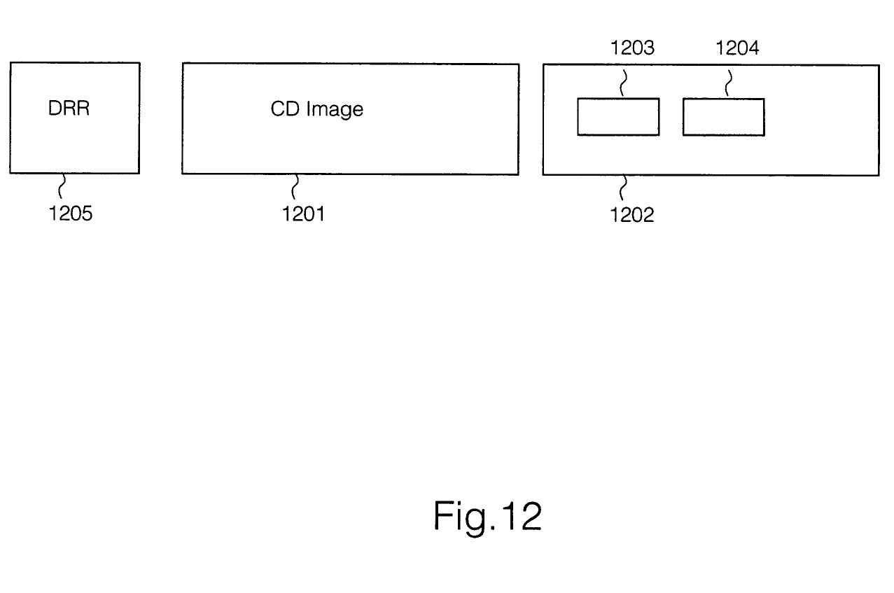

As described in WO 00/08561 the bootable image is stored as a CD image 1201 as indicated in FIG. 12. The bootable image is stored on tape in front of an actual file system back-up data body 1202 which may comprise one or more back-up data set files 1203 and 1204 for example. In accordance with the present invention the DRR record is, in the best mode contemplated, stored at the front of the bootable image 1201 as indicated at 1205. Thus, DRR 1205 is logically stored in front of the CD image 1201 which in turn is stored logically in front of the back-up data body files 1202. The positioning of the DRR as described is necessary for various reasons as now discussed. Firstly, the DRR must not be rewritten at every rewrite to the back-up storage device since if this was the case then this record would only be the record for the latest situation as regards image content and files stored in portion 1202. For example, if a user was to take the back-up storage tape and append some data to it then allowing the DRR to be rewritten in this circumstance would not provide physical-logical mappings that corresponded to the situation at the time when the original back-up was taken in order to run the original system back-up and recovery (OBDR) procedure. To ensure that such a situation does not arise the following rule is incorporated in the relevant processing logic:

The DRR record is cached in RAM that is on the tape drive; and

The DRR record is only actually written to the back-up storage device under circumstances wherein the logical block 0 of the tape is being written or wherein an erase or write of the first block is being undertaken. Thus, it is only at the point of actually writing the logical block 0 that the back-up storage tape is actually invoked to write the DRR record.

The DRR record has to be available to the RAID controller BIOS and therefore it is clearly not possible to locate the DRR within image 1201 or within is the file system back-up data body 1202. Alternatives could be implemented, such as locating the DRR in the CD image portion 1201, but this would require certain changes to be made to the CD ROM image beyond the format defined by ISO 9960. This in turn has lended itself to use of the read/write buffer process detailed in FIG. 11 because the read/write buffer process is available at all times, is readily implemented in the data storage device and is also convenient considering that there is no checking of the DRR prior to storage. Therefore, in summary, the relevant rules to be used in conjunction with the process detailed in FIG. 11 are:

Cache DRR record in RAM that is on the tape drive; and

Write DRR to tape only when write logical block 0 of tape.

As those skilled in the art will realise the invention may be considered to comprise mechanisms for enabling storage of a record of physical drive—logical drive mapping data to be stored on a suitably configured tape storage device. As described this enables a failed computer system to be rebooted in a simple manner thereby providing a RAID reconfigured in a state substantially equivalent to that prior to the system failure. The principles and methods described in WO 00/08561 are applicable for use with the present invention. The present invention may thus be considered to be an enhancement enabling the methods and apparatus described in WO 00/08561 to be used in relation to computer systems using RAID arrays. The final solution for the final RAID configuration re-established may not necessarily be the one that was present before the system failure, but is considered to be derived efficiently and to reduce down times and the like for the majority of situations which more inexperienced users may otherwise be faced with.

1. In a computer system comprising an operating system stored on a RAID device comprising an array of data storage devices and a RAID controller, an automatic method of substantially restoring a configuration of said RAID in the event of a system failure, said method comprising the steps of:
on a system back-up memory device storing a recovery record of physical drive to logical drive mapping information for said RAID device;
configuring said raid controller to enable said recovery record to be processed in response to a detected system failure; and
in response to said detected system failure, utilizing said recovery record information to restore said configuration of said raid array.

2. The method according to claim 1, wherein said automatic restore comprises one button disaster recovery procedure initiated by a human operator of said system.

3. The method according to claim 1, wherein said recovery record is stored on a back-up storage device comprising a magnetic tape.

4. The method according to claim 1, wherein said recovery record is only stored to said back-up device when writing logical block zero of said back-up device.

5. The method according to claim 1, wherein said recovery record is cached in RAM.

6. The method according to claim 1, wherein said recovery record is configured at the level of said computer operating system.

7. The method according to claim 1, wherein said step of utilizing said processed record information to restore said configuration of said RAID array comprises sufficient re-establishment of said configuration to accommodate all required logical drives.

8. The method according to claim 1, wherein said recovery record is compared with the configuration of said RAID array prior to said computer system entering said automatic restoration of said configuration of said RAID array.

9. The method according to claim 1, wherein said step of processing said record information to restore said configuration of said RAID array comprises said RAID controller assessing a plurality of alternative suitable configuration solutions.

10. The method according to claim 1, wherein said recovery record is stored on said back-up media in a configuration to enable immediate reading of said recovery record by said RAID controller during a system recovery.

11. The method according to claim 10, wherein said recovery record is stored on said back-up media in front of a latest re-bootable CD image of said system.

12. The method according to claim 1, wherein said detection of a system failure comprises the steps of:
reading a recovery record stored on said RAID controller;
reading physical-logical mapping information stored on said RAID array;
comparing said mapping information stored in said RAID array with said RAID controller recovery record; and
signaling that a system failure has occurred if said mapping information on said RAID controller differs from that stored on said RAID array.

13. The method according to claim 1, wherein said recovery record holds configuration information relating to each logical drive of said RAID array, said configuration information comprising at least the following for each said logical drive:
RAID controller identity;
logical drive size (Gigabytes); and
RAID level.

14. The method according to claim 13, wherein said configuration information additionally comprises:
the span of each said logical drive; and
the number of RAID stripes for each said logical drive.

15. The method according to claim 13, wherein said recovery record is configurable to store configuration information for 26 said logical drives.

16. An electronically stored disaster recovery record configurable for use in recovering a computer system from a system failure, said record comprising information relating to the configuration of a plurality of logical drives of a RAID array, said configuration information comprising at least the following for each said logical drive:
RAID controller identity;
logical drive size (Gigabytes); and
RAID level.

17. A record according to claim 16, wherein said configuration information additionally comprises:
a span of each said logical drive; and
the number of RAID stripes for each said logical drive.

18. A computer system back-up apparatus configured for storing backup information of a RAID computer system, said apparatus comprising means for recording:
system back-up data;
a bootable CD image of said system; and
a disaster recovery record comprising mapping information between physical and logical hard drives of said RAID array system prior to a disaster.

19. The computer system back-up apparatus as claimed in claim 18, wherein said recording is configured to store said disaster recovery record in front of the other said stored data.

20. A RAID array controller configured for use in a RAID array computer system, said RAID controller being further configured to create a disaster recovery record of physical-logical mapping information of said RAID array and thereafter to enable transmission of said recorded information to be made to a data back-up storage device.

21. A RAID array controller as claimed in claim 20, wherein said disaster recovery record is cached in RAM.

22. A RAID array controller as claimed in claim 20, wherein said disaster recovery record is written to said back-up storage device upon logical block zero of said back-up device being written.

23. A RAID array controller as claimed in claim 20, wherein said disaster recovery record is written to said back-up device following an erase operation being performed in respect of the system back-up-information already stored on said back-up device.

24. A method of substantially restoring a RAID device operating system configuration, comprising: providing a RAID device having stored thereon a recovery record of physical drive to virtual drive mapping information for said RAID device, and configured to enable the recovery record to be processed in response to a detected system failure; and responding to detected system failure by using the recovery record to restore the RAID device configuration; wherein said recovery record is stored on tape back-up media in front of a latest rebootable CD image of the operating system, for enabling immediate reading of the recovery record by the RAID device during a system recovery in response to a single operator action.

25. A RAID device having a substantially restorable operating system configuration, the device being operable to store a recovery record of physical drive to virtual drive mapping information on tape back-up media in front of a latest rebootable CD image of the operating system, so as to thereby enable immediate reading of the recovery record by the RAID device during a system recovery in response to a single operator action, for restoring the operating system configuration in response to a detected system failure.
